(19) United States
(12) Patent Application Publication
(10) Pub. No.: US 2022/0058810 A1
(43) Pub. Date: Feb. 24, 2022

(54) TEST SYSTEM AND TEST METHOD FOR WINDSHIELD WIPERS

(71) Applicant: Robert Bosch GmbH, Stuttgart (DE)

(72) Inventor: Markus Koberstaedt, Buehl (DE)

(21) Appl. No.: 17/406,384

(22) Filed: Aug. 19, 2021

(30) Foreign Application Priority Data
Aug. 20, 2020 (DE) 102020210549.9

(51) Int. Cl. G06T 7/20; G01M 17/00

(52) U.S. Cl. CPC G06T 7/20; G06T 2207/30252; G01M 17/00

(57) ABSTRACT

A test system (10) for windshield wipers (18). In one example, the test system has a camera unit (12) which generates image data (B) and captures an image of a windshield wiper (18) moving on a window (16), and an evaluation unit (30) for evaluating the image data (B) with respect to a wiping frequency and/or an objective wiping quality. A test method for windshield wipers (18) is also proposed. The method includes aligning the camera unit (12) with a field of vision (14) of a window (16), image data (B) are generated, and a wiping frequency of the windshield wiper (18) is then determined and/or a wiping quality of the windshield wiper (18) is determined by means of an evaluation unit (30). The wiping frequency and/or key figures of the wiping quality is/are output in a display (34).

### BACKGROUND OF THE INVENTION

The invention relates to a test system and to a test method.

Test methods for windshield wipers are already known, in which the windshield wipers are moved over a wet window and a subjective assessment of the wiping quality and a measurement of the wiping frequency are carried out by a human observer by means of a visual inspection.

### SUMMARY OF THE INVENTION

The test system according to the invention has the advantage that a camera unit which generates image data and is intended to capture an image of a windshield wiper moving on the window and an evaluation unit for evaluating the image data with respect to a wiping frequency and/or an objective wiping quality are provided. This makes it possible to quickly and objectively test the wiping frequency and/or the wiping quality.

In this case, the camera advantageously captures a wiping region which is crossed by the windshield wiper in an oscillating manner at the wiping frequency in order to achieve a test result which is as accurate as possible.

It is particularly advantageous if the camera unit captures a field of vision of the window which also corresponds, in particular, to the field of vision of the driver of the motor vehicle. This achieves a particularly relevant test result.

It can also be considered to be advantageous if the evaluation unit has means for generating one or more key figures with respect to the wiping quality since an absolutely objective result is achieved in this manner and can also be processed further in a simple manner.

In this case, it is particularly advantageous if at least one key figure is a measure of the wetting homogeneity.

It is likewise advantageous in this case if at least one key figure is a measure of a wetting layer thickness.

The image data can be advantageously evaluated in an optimum manner by means of a system based on artificial intelligence, a so-called AI system.

It is also advantageous if the camera unit and the evaluation unit are arranged in a smartphone since smartphones are available cheaply and in high quality.

The test method according to the invention has the advantage that a simple and cost-effective test method for objectively testing the windshield wiper is provided by aligning the camera unit with a field of vision of the window, generating image data, determining a wiping frequency of the windshield wiper or determining a wiping quality of the windshield wiper by means of an evaluation unit, and outputting the wiping frequency and/or key figures of the wiping quality in a display.

In this case, it is particularly advantageous if feedback is effected with the windshield wiper instead of or in addition to outputting the wiping frequency and/or the key figures of the wiping quality in a display.

### BRIEF DESCRIPTION OF THE DRAWINGS

An exemplary embodiment of the invention is illustrated in the drawings and is explained in more detail in the following description. In the drawings:

FIG. 1 shows a schematic illustration of a test system according to the invention during a test operation, and

FIG. 2 shows a flowchart of a test method according to the invention.

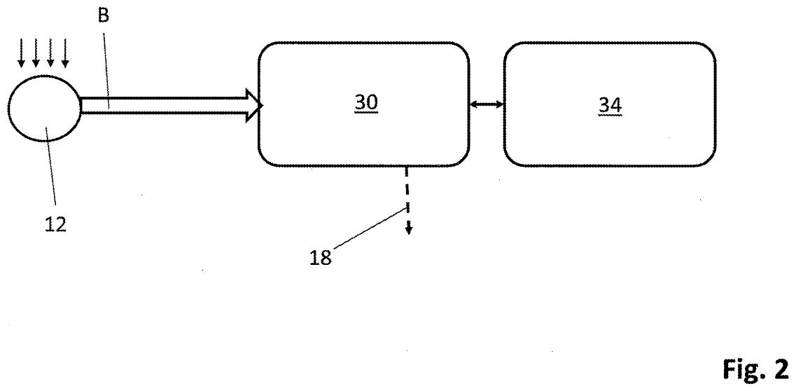

### DETAILED DESCRIPTION

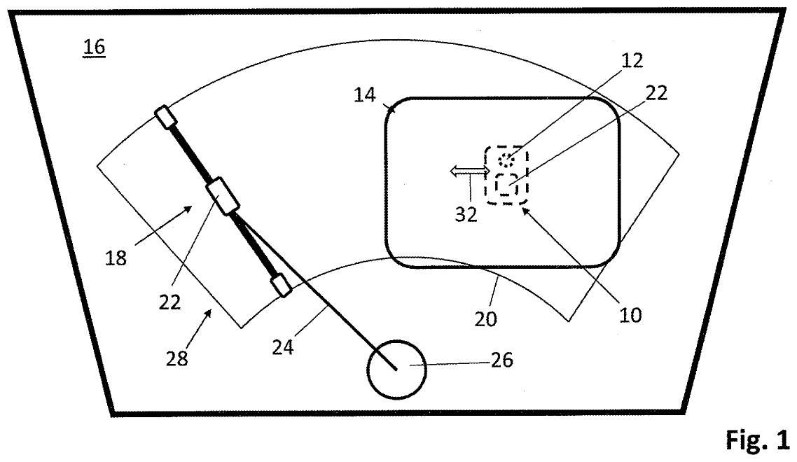

FIG. 1 shows a schematic illustration of a test system 10 according to the invention during a test operation.

The test system 10 has a camera unit 12 which generates image data B relating to a field of vision 14 during operation. The field of vision 14 is part of a window 16, here a windshield of a motor vehicle, which is crossed by a windshield wiper 18. During the test operation, the windshield wiper 18 moves in an oscillating manner at a wiping frequency W over a part of the window 16, thus forming a wiping region 20. The field of vision 14 is arranged substantially completely within this wiping region 20 and the test system 10 is therefore positioned for a test operation in such a manner that the field of vision 14 is substantially completely within the wiping region 20.

In order to produce the oscillating movement of the windshield wiper 18, the latter is fastened, by means of a fastening element 22, to a wiper arm 24 which can be caused to move in an oscillating manner by a wiping drive 26, for example an electric motor. The windshield wiper 18, the fastening element 22, the wiper arm 24 and the wiping drive 26 in this case form a wiping apparatus 28.

The test system 10 also has an evaluation unit 30 which is used to evaluate the image data B. The test system 10 may also have a display 34 which is used to output information and to control the test system 10. This display may be in the form of a touchscreen and may therefore constitute the man-machine interface of the test system 10.

The evaluation unit 30 may use the image data B to generate one or more key figures which characterize the wiping quality and can be displayed on the display.

A communication unit 32 which is able to communicate with the wiping apparatus 28 is also provided in the test system 10. For example, the evaluation unit 30 may determine a characteristic diagram of key figures and may control the wiping apparatus 28 with or without a display on the display 34. The evaluation unit 30 can also determine calibration parameters from the key figures here and can transmit them to the wiping apparatus 28 for the calibration of the latter. For this purpose, the wiping apparatus 28 may have a memory for storing the calibration parameters. The test system 10 and therefore the camera unit 12, the communication unit 32 and the evaluation unit 30 are arranged in a smartphone. The latter has a high-resolution camera as a camera unit 12 and has a processor for evaluating the image data B, which processor can carry out the test method described below.

The test method for windshield wipers 18 is explained in more detail below.

In a first step, the camera unit 12 of the test system 10 is aligned with the desired field of vision 14 of the window 16. In a second step, image data B are generated and are transmitted to the evaluation unit 30. In a third step 40, key figures characterizing the wiping quality are determined by the evaluation unit 30. Alternatively or additionally, it is also possible to determine the wiping frequency, that is to say the oscillating frequency of the windshield wiper 18. For this purpose, the evaluation unit has an AI system which evaluates the image data B by means of artificial intelligence. In this case, the layer thickness of a wetting of the window 16 or the homogeneity, that is to say the uniformity, of the wetting of the window 16 can also be determined as key figures. The wiping result, for example streaks or stripes of liquid, can thus be objectively represented in terms of quality by key figures. In a fourth step, the key figures are output on the display 34. In addition, the image data B, that is to say the image itself recorded by the camera unit 12, can be output on the display 34 at the same time. This may be used, on the one hand, to check the plausibility and, on the other hand, to also additionally give the subjective impression of the wiping quality.

In a variation of the invention, the wiping apparatus 28 can be additionally controlled via the communication unit 32 in order to be able to make changes, for example the speed of the windshield wiper 18 or the intervals of time between the individual oscillating movements, in particular with regard to the determined key figures.

In a further variation, the evaluation unit 30 may provide different regions in the field of vision 14 which are weighted differently. For example, the central region, that is to say the geometrical center of the field of vision 14, may be given a higher weighting than edge regions. Depending on the choice of the field of vision 14, the field of vision of the vehicle driver may likewise be given a higher weighting than edge regions or the field of vision of the front-seat passenger.

1. A test system (10) for windshield wipers (18), the test system comprising:
a camera unit (12) which generates image data (B) and is configured to capture an image of a windshield wiper (18) moving on a window (16), and
an evaluation unit (30) for evaluating the image data (B) with respect to a wiping frequency and/or an objective wiping quality.

2. The test system (10) according to claim 1, wherein the camera unit (12) captures a wiping region (20) which is crossed by the windshield wiper (18) in an oscillating manner at the wiping frequency.

3. The test system (10) according to claim 1, wherein the camera unit (12) captures a field of vision (14) of the window (16).

4. The test system (10) according to claim 1, wherein the evaluation unit (30) has means for generating one or more key figures with respect to the wiping quality.

5. The test system (10) according to claim 4, wherein at least one key figure is a measure of the wetting homogeneity.

6. The test system (10) according to claim 4, wherein at least one key figure is a measure of a wetting layer thickness.

7. The test system (10) according to claim 1, wherein the evaluation unit (30) has an AI system.

8. The test system (10) according to claim 1, wherein the camera unit (12) and the evaluation unit (30) are arranged in a smartphone.

9. A test method for windshield wipers (18), the test method performed with a camera unit (12) which generates image data (B) and configured to capture an image of a windshield wiper (18) moving on a window (16), the method comprising the steps of:
aligning the camera unit (12) with a field of vision (14) of a window (16)
generating image data (B)
determining a wiping frequency of the windshield wiper (18) or determining a wiping quality of the windshield wiper (18) by means of an evaluation unit (30)
outputting the wiping frequency and/or at least one key figure of the wiping quality in a display (34).

10. The test method according to claim 9, wherein feedback is effected with the windshield wiper (18) instead of or in addition to outputting the wiping frequency and/or key figures of the wiping quality in a display (34).
